(19) United States
(12) Patent Application Publication
(10) Pub. No.: US 2012/0006425 A1
(43) Pub. Date: Jan. 12, 2012

(54) FLUID SYSTEM

(75) Inventors: Tatsuya Hayashi, Kyoto-shi (JP); Takashi Kanamaru, Kyoto-shi (JP); Yuichiro Hashimoto, Kyoto-shi (JP)

(73) Assignees: HORIBA STEC, CO., LTD., Kyoto-shi (JP); IHARA SCIENCE CORPORATION, Tokyo (JP)

(21) Appl. No.: 13/181,301

(22) Filed: Jul. 12, 2011

(30) Foreign Application Priority Data
Jul. 12, 2010 (JP) 2010-158156
Jul. 8, 2011 (JP) 2011-151992

(51) Int. Cl. F16L 3/00

(52) U.S. Cl. 137/343

(57) ABSTRACT

In order to simplify a configuration of a fluid system without increasing the number of parts of an intermediate support body while using a common intermediate support body, the fluid system includes a fluid circuit device configured by connecting a plurality of fluid units for controlling or measuring a state of fluid using pipes and pipe joints and a holding mechanism for holding the fluid circuit device, wherein the holding mechanism includes a base member and the intermediate support body interposed between the fluid circuit device and the base member so as to couple the fluid circuit device and the base member, and wherein one end of the intermediate support body is attached to a respective pipe joint and the other end thereof is attached to the base member so that each of the pipe joints is connected to the base member.

### TECHNICAL FIELD

The present invention relates to a fluid system including a fluid circuit device configured by connecting a plurality of fluid units for controlling or measuring a state of fluid using pipes and pipe joints and further including a holding mechanism for holding the fluid circuit device.

### BACKGROUND ART

As a fluid circuit device for use in a semiconductor manufacturing process and the like, there is exemplified a configuration that a plurality of fluid units are laterally and longitudinally arranged while the fluid units adjacent to each other are connected using pipes and pipe joints so that the heights of the pipes are made uniform. In this configuration, the fluid circuit device is held by, e.g., a holding mechanism which includes a base member like a substrate and intermediate support bodies like brackets so that a bottom surface of each of the fluid units is fixed to the base member through each of the intermediate support bodies.

In this configuration, however, there may be likely an irregularity in height from the bottom surfaces of the fluid units to the pipes fixed to the fluid units depending on types of the fluid units. In that case, the heights of the intermediate support bodies are varied depending on the differences in height thereof so that the heights of the pipes are made uniform. Therefore, it is necessary to use the intermediate support bodies of different heights depending on the types of the fluid units.

In contrast, as disclosed in Patent Literature 1, there may be considered a fluid unit attachment structure in which an intermediate support body (referred to as “supporting medium” in Patent Literature 1) is attached to each of the pipes fixed to the fluid units. With this configuration, the heights of the pipes can be made uniform using the intermediate support bodies having the height in common.

### CITATION LIST

### Patent Literature

Patent Literature 1: JP2009-264587A

### SUMMARY OF INVENTION

### Technical Problem

However, it is impractical to directly attach an intermediate support body to a pipe with screws because it is difficult to provide a threaded hole in the pipe. Accordingly, in the invention described in Patent Literature 1, the intermediate support body includes two members so that each pipe is sandwiched between the respective two members (see Paragraphs 0087, 0088 and FIG. 6). That is, in the case of attaching the intermediate support body to the pipe, it is required that a specific configuration that each of the pipes is sandwiched or externally fitted by the two members of the intermediate support body, and therefore it may be likely to lead to an increase in number of parts or complexity in structure, undesirably.

Therefore, the present invention has been made to solve the problems at once, and an essential object thereof is to provide a fluid system capable of simplifying a configuration without increasing the number of parts of an intermediate support body while using a common intermediate support body.

That is, the fluid system pertaining to one aspect of the present invention includes a fluid circuit device configured by connecting a plurality of fluid units for controlling or measuring a state of fluid using pipes and pipe joints, and a holding mechanism for holding the fluid circuit device, wherein the holding mechanism includes a base member and intermediate support bodies each of which is interposed between the fluid circuit device and the base member so as to couple the fluid circuit device and the base member, and wherein one end of each intermediate support body is attached to a respective pipe joint and the other end thereof is attached to the base member so that the intermediate support bodies connect each of the pipe joints to the base member.

With this configuration, since an intermediate support body is attached to each of the pipe joints, there is no need to use the intermediate support bodies having different heights, and the common intermediate support body can be used, as disclosed in Patent Literature 1. Moreover, since the pipe joint, for example, is relatively thick and it is not so difficult to provide a threaded hole there, the intermediate support body can be easily attached to the pipe joint directly by a screw even though the intermediate support body has a simple structure such as a column body. Further, regarding the attachment procedure, the paired fluid units may be connected using the pipe joint after the intermediate support body is attached to the pipe joint and the base member. Otherwise, the intermediate support body may be attached to the pipe joint and the base member after the paired fluid units are connected using the pipe joint. Thus, a preferable attachment procedure can be selected depending on an attachment situation and it is possible to improve workability. Also, in the conventional system, when a fluid unit is detached for maintenance or replacement thereof, for example, in such a case where a fluid unit such as a valve is clogged after piping, it is necessary to respectively detach the intermediate support body and the pipe joint, and the detached pipe joint may be held to avoid damage from falling down, and this is troublesome. In contrast, according to the present invention, since the intermediate support body is attached to the pipe joint, there is no need to detach the intermediate support body, and it is sufficient to detach only the pipe joint. In addition, since the pipe joint is connected to the base member, there is no need to hold the pipe joint to avoid damage from falling off. Thus, the fluid unit can be easily detached and attached at the time of maintenance or replacement thereof.

In order to improve a degree of freedom in a piping layout, it is desirable that each of the pipe joints is pivotably connected to the base member by the intermediate support body.

In the case where the intermediate support body is attached to the base member with a backlash so as to be able to change its position or to be movable at least within a prescribed range, dimensional errors of each of the fluid units, pipes and pipe joints can be absorbed by the backlash.

In the case where the base member has a first slide groove and a second slide groove formed for the other end of the intermediate support body to be slidably fitted thereto and the second slide groove is branched from the first slide groove in a direction different from the extending direction of the first slide groove, even in the case where the arrangement of the pipe joint is changed by, e.g., adding another fluid unit, the intermediate support body with the pipe joint attached thereto can be moved along the first slide groove so that the arrangement of the pipe joint can be changed and the base member can be shared in common among the multiple pipe joints. Moreover, in the case where the intermediate support body is fitted to only the first slide groove, the fluid circuit device is likely to be moved along the first slide groove. In order to avoid this, it is necessary to provide an additional member for securing the fluid circuit device. Whereas, in the present invention, since the second slide groove extending in a direction different from the first slide groove is formed, the base member and the pipe joint are attached to each other through the intermediate support body, which is arranged to be fitted to either the first slide groove or the second slide groove so that the fluid circuit device can be secured without providing an additional member for securing.

For easy attachment and detachment of the intermediate support body, it is desirable that the first slide groove or the second slide groove is provided with a wide space portion through which the other end of the intermediate support body can be inserted.

In the case where the base member includes a plurality of lengthy rectangular plate bodies which are arranged to be spaced with gaps each other so that each of the gaps forms a respective first slide groove while at least one second slide groove is formed in each of the plate bodies, each of the slide grooves can be expanded by adding a plate body, or reduced by removing a plate body, or the position of the second slide groove etc. can be changed by changing the plate body.

As a specific aspect of the present invention, there may be exemplified a configuration that the intermediate support body is schematically column shaped and a groove is formed in the side peripheral surface thereof so that the groove is fitted to the plate body which forms the slide groove.

In order to further improve the workability, it is desirable that, each of the pipe joints includes a series of unit members and those adjacent to each other are rotatably connected and the pipe joints each further include a fastener for connecting the unit members at both ends so that the series of unit members are formed to be annular, wherein the pipe joint is externally fitted to the opposite ends of a pair of pipes and these pipes are connected in series to each other by tightening the fastener, and wherein the intermediate support body is attached to the unit member located on the bottom of the pipe joint. In the conventional configuration, a worker should hold the pipe joint at the time of attaching the pipe joint to the pipe. Whereas, in the present invention with the configuration as described above, after the unit member on the bottom of the pipe joint is held on the base member, the pipe can be connected using the pipe joint and there is no need to hold the pipe joint at the time of piping construction.

### Advantageous Effects of Invention

Therefore, according to the present invention, the system configuration can be simplified without increasing the number of parts of the intermediate support body while using a common intermediate support body.

### BRIEF DESCRIPTION OF THE DRAWINGS

FIG. 1 is a side view of a fluid system in an embodiment of the present invention.

FIG. 2 is a plan view of the fluid system in the same embodiment.

FIG. 3 is an exploded view of a pipe joint in the same embodiment.

FIG. 4 is a diagram showing a fixed state of the pipe joint in the same embodiment.

FIG. 5 is a longitudinal A-A section view of the pipe joint in the same embodiment of FIG. 4.

FIG. 6 is a diagram showing a released state of the pipe joint in the same embodiment.

FIG. 7 is an overall perspective view of a base member in the same embodiment.

FIG. 8 is an overall perspective view of an intermediate support body in the same embodiment.

FIG. 9 is a side view showing a state of attaching the pipe joint to the intermediate support body in the same embodiment.

FIG. 10 is a partial longitudinal section view showing a state of attaching the pipe joint to the base member through the intermediate support body in the same embodiment.

FIG. 11 is a plan view showing an initial state of an assembling process of the fluid system in the same embodiment.

FIG. 12 is a plan view showing a midway assembling process of the fluid system in the same embodiment.

FIG. 13 is a side view showing a state of attaching the pipe joint to the intermediate support body in another embodiment of the present invention.

### DETAILED DESCRIPTION OF THE EMBODIMENTS

The following describes a fluid system 100 pertaining to one embodiment of the present invention referring to the accompanying drawings.

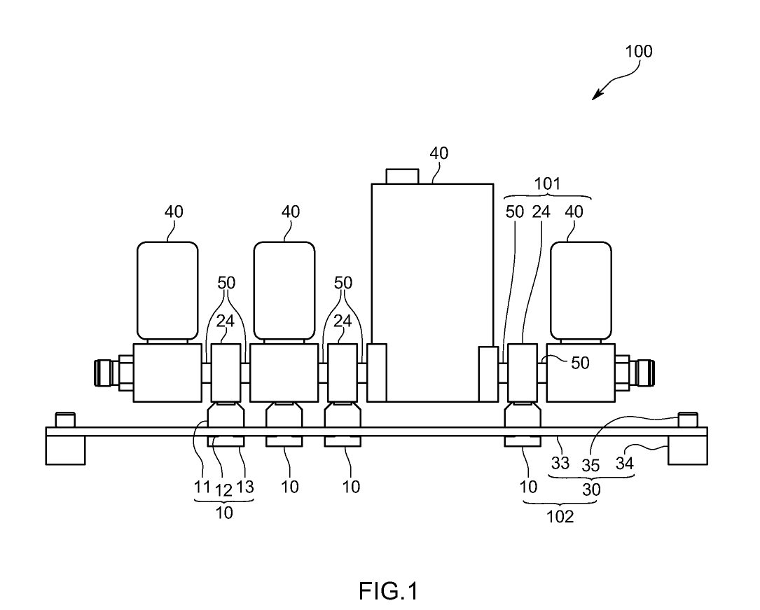

The fluid system 100 pertaining to the present embodiment is adapted to configure, for example, a gas panel device that supplies a process gas, etc., to a semiconductor manufacturing apparatus. As shown in FIG. 1, the fluid system 100 includes a fluid circuit device 101 which is configured by connecting a plurality of fluid units 40 for controlling or measuring a state of the fluid using pipes 50 and pipe joints 24, and a holding mechanism 102 for holding the fluid circuit device 101. It is noted here that the fluid unit 40 is, for example, a pressure sensor, a mass flow controller, a valve and the like.

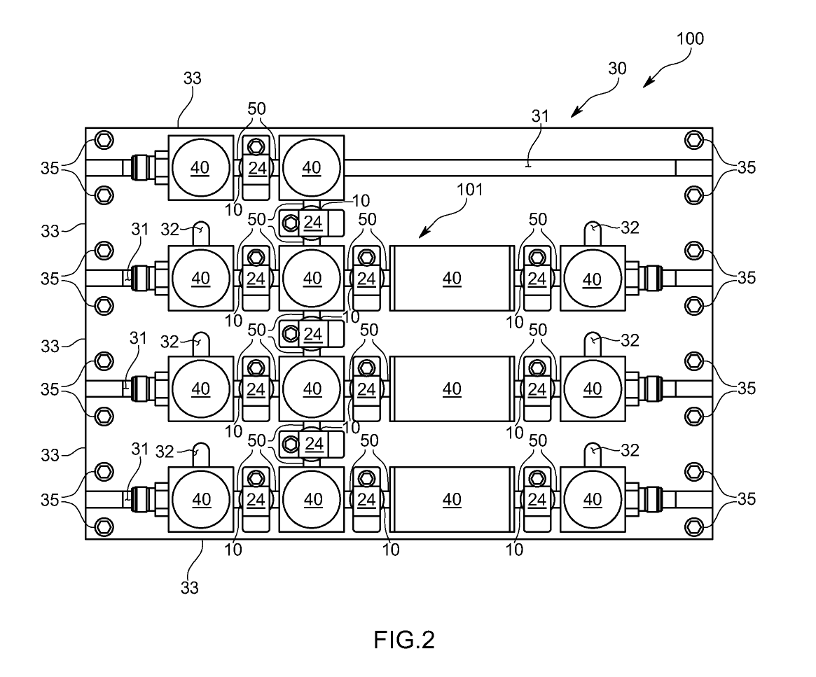

As shown in FIG. 2, the fluid circuit device 101 is configured by arranging the plurality of fluid units 40 in row and column so as to be connected in a flat plane manner. More specifically, the plurality of fluid units 40 are arranged in series in a manner such that the respective adjacent fluid units 40 are connected using the pipes 50 and pipe joints 24 so as to configure a plurality of row fluid lines. Then, the plurality of row fluid lines are arranged in parallel in a similar manner such that the respective adjacent row fluid lines are connected using the pipes 50 and pipe joints 24 so as to configure a column fluid line. Thus, the fluid circuit device 101 is configured by the respective row and column fluid lines. For convenience of explanation, an extending of the row fluid line is referred to as “row direction” and an extending direction of the column fluid line is referred to as “column direction”, hereinafter.

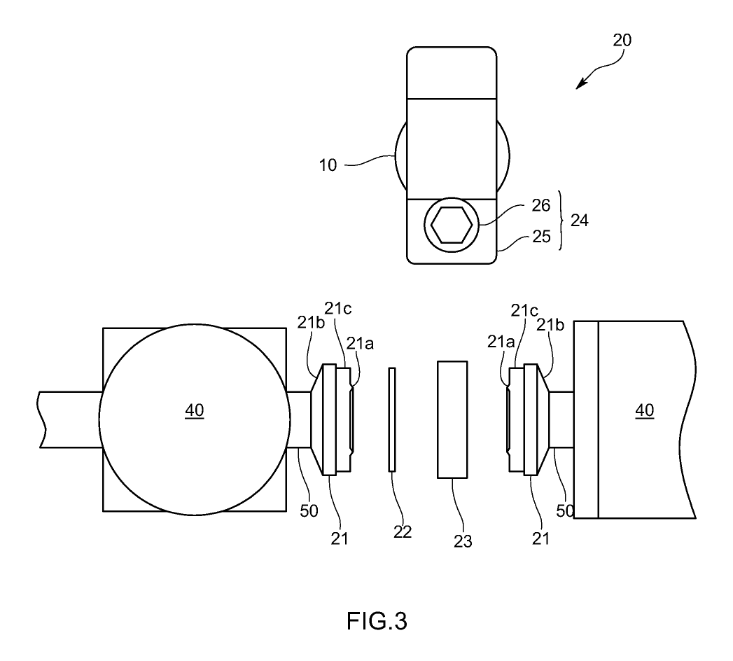

Next, a joint mechanism 20 for connecting the fluid units 40 using the pipes 50 and the pipe joints 24 is described. First, the pipe 50 is described. As shown in FIG. 3, each of the pipes 50 has a proximal end previously connected to an inlet/outlet port of the fluid unit 40, and a flange part 21 to be described later is provide at its tip edge. Here, the pipes 50 all having the same diameter are used.

As shown in FIG. 3, the joint mechanism 20 includes paired flange parts 21 each of which is integrally formed with an outer periphery of the tip edge of the pipe 50, a gasket 22 interposed between the paired flange parts 21, a positioning ring 23 for coaxially aligning the paired flange parts 21, and the pipe joint 24 for coupling the paired flange parts 21 by pressing.

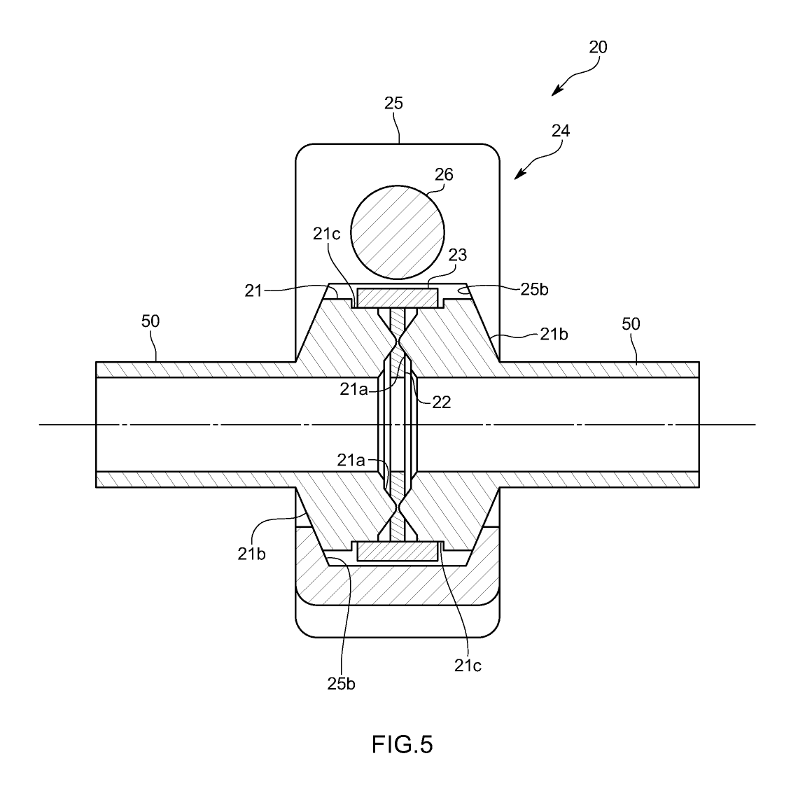

As shown in FIG. 5, each of the flange parts 21 has a schematically annular plate shape and an annular shaped protrusion 21a is provided on its tip edge surface (also, referred to as “opposing surface” hereinafter). On a rear surface of the flange part 21, there is formed an inclined surface 21b with its diameter increasing toward the rear end thereof. On a tip edge portion 21c of a side peripheral surface of the flange part 21, there is formed a step portion to have a diameter smaller than that of the other part of the side peripheral surface.

As shown in FIG. 5, the gasket 22 has an annular plate shape with a uniform thickness, and an inner diameter thereof is matched with an inner diameter of the pipe 50 and an outer diameter thereof is matched with an outer diameter of the tip edge portion 21c of the flange part 21.

As shown in FIG. 5, the positioning ring 23 has a cylindrical shape with its inner diameter defined to be matched with the outer diameter of the tip edge portion 21c of the flange part 21 so as to be externally fitted to the tip edge portion 21c of the flange part 21 without a backlash.

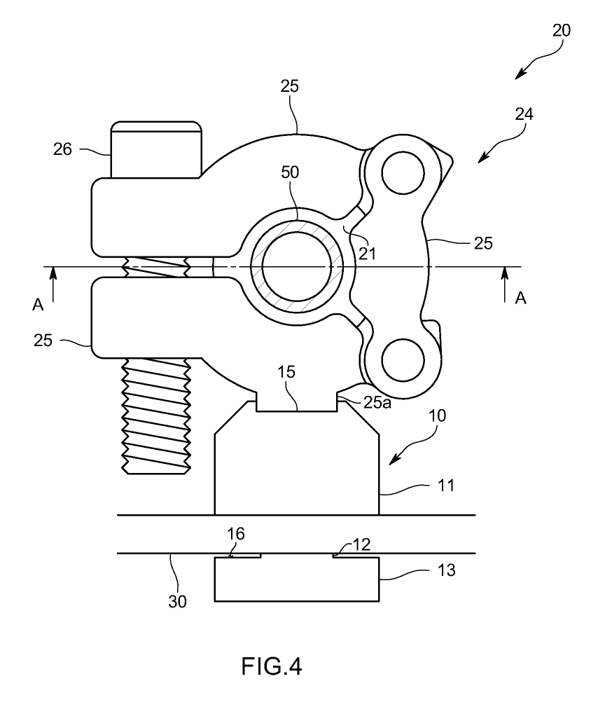

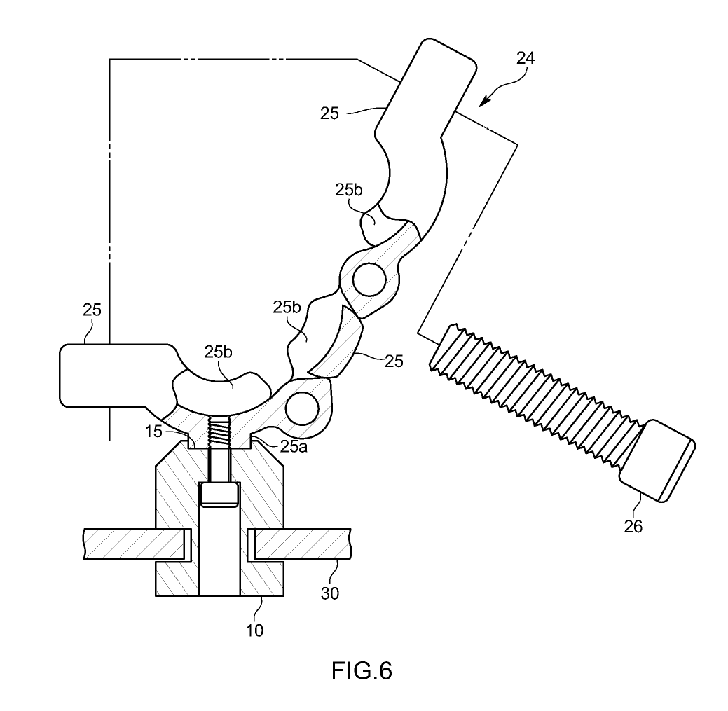

FIG. 4 shows a fastened state of the pipe joint 24 and FIG. 6 is a released state thereof. As shown in FIGS. 4 and 6, the pipe joint 24 includes a series of unit members 25 which are connected in series in a manner such that the respective adjacent unit members 25 are rotatably connected to each other, and the pipe joint 24 a fastener 26 that couples the both ends of the unit members 25 so as to form an annular shape of the series of unit members 25. In an inner peripheral surface of each of the unit members 25 (three in this example), there is formed a fitting groove with a bottom extending in a circumferential direction. On a side surface of the fitting groove, there is formed an inclined surface 25b corresponding to the inclined surface 21b formed on the rear surface of the flange part 21. Moreover, a thick part 25a is provided in the unit member 25 which is located at the bottom in the fastened state, and a coupling member (i.e., bolt, in this case) is screwed into a female threaded hole defined in the thick part 25a so that the intermediate support body 10 (to be described later) is attached.

In the case where the adjacent pipes 50 are connected by the joint mechanism 20 in this manner, one end of the positioning ring 23 is first fitted to an outer periphery of the tip edge portion 21c of the flange part 21 secured to one of the pipes 50. Next, the gasket 22 and the tip edge portion 21c of the flange 21 secured to the other pipe 50 are sequentially fitted into the other end of the positioning ring 23. Thus, the paired flange parts 21 and the gasket 22 are held with their central axes coaxially aligned.

Next, in the released state of the pipe joint 24 as shown in FIG. 6 where the unit members 25 at both ends of the pipe joint 24 are not coupled by the fastener 26, the paired flange parts 21 are fitted into the fitting grooves formed in the pipe joint 24. Then, as shown in FIG. 4, the unit members 25 at both ends of the pipe joint 24 are coupled to be fastened by the fastener 26. Thus, the inner diameter of the pipe joint 24 is reduced to be narrower so that the inclined surfaces 25b of the fitting grooves radially press the inclined surfaces 21b of the paired flange parts 21. At this time, as shown in FIG. 5, there is generated a component of force in a direction of axially bringing the paired flange parts 21 into close contact with each other by the inclined surfaces 21b of the paired flange parts. By this component of force, the paired flange parts 21 are crimped with their annular protrusions 21a engaged into the gasket 22 so that the paired pipes 50 are air-tightly connected to each other.

As shown in FIG. 1, the holding mechanism 102 includes the base member 30 and the intermediate support body 10, wherein the intermediate support body 10 is interposed between the fluid circuit device 101 and the base member 30 so that the fluid circuit device 101 and the base member 30 are coupled.

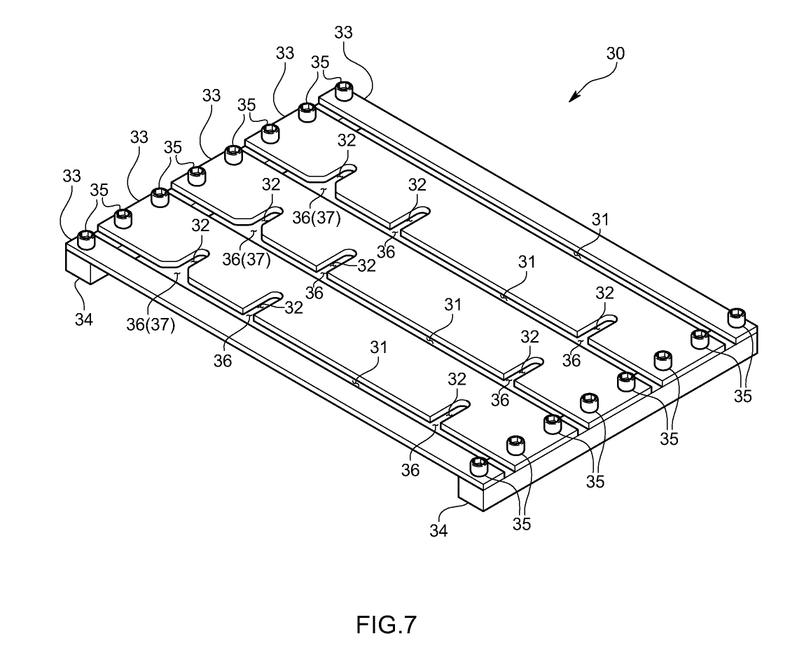

As shown in FIG. 7, the base member 30 is schematically faceplate-shaped and the fluid circuit device 101 is attached to one surface (also, referred to as “attachment surface” hereinafter) thereof through the intermediate support body 10. The base member 30 includes a plurality of plate bodies 33, a pair of holding plates 34 and coupling members 35 (i.e., “bolt” in this example) for coupling the plate bodies 33 and the paired holding plates 34.

Each of the plate bodies 33 has a lengthy rectangular shape laterally extending with a uniform thickness and the lengths in the longitudinal direction thereof are coincident. The plate bodies 33 have their faceplate portions formed to be coplanar in level and the plate bodies 33 are arranged in parallel evenly spaced with each other. All of the plate bodies 33 other than those located at both ends thereof are formed with second slide grooves 32 (to be described later) passing through the plate bodies in the thickness direction. A pair of elongated thick plate-shaped holding plates 34 is attached to both edges of the back surfaces of the plate bodies 33 using the coupling members 35.

The base member 30 is formed with first slide grooves 31 and second slide grooves 32 for slidably fitting the other ends of the intermediate support bodies 10 thereto. The first slide grooves 31 are formed of the spaced gaps laterally extending between the respective plate bodies 33 and the second slide grooves 32 are formed to be branched from each of the first slide grooves 31 in a direction different from the extending direction of the first slide grooves 31 (that is, in the column direction perpendicular to each of the first slide grooves 31 in this example). In this example, the second slide grooves 32 are formed in the same positions of the plate bodies 33 in a manner that the second slide grooves 32 are aligned in the column direction in a state that the plate bodies 33 are arranged in parallel. However, the second slide grooves 32 may be formed in different positions of the plate bodies 33 in a manner that the second slide grooves 32 are shifted from each other.

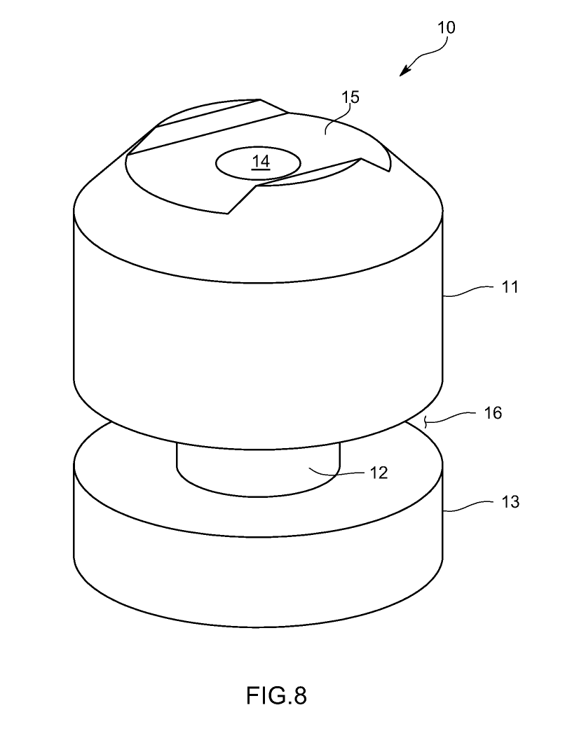

As shown in FIG. 8, the intermediate support body 10 is hollow and schematically column shaped with its one end attached to the pipe joint 24 and the other end attached to the base member 30 so that the pipe joint 24 is connected to the base member 30. Specifically, the intermediate support body 10 includes a head portion 11, a base portion 13 and a neck portion 12 connecting between the head portion 11 and the base portion 13, and these portions are integrally formed.

The head portion 11 has a schematically cylindrical shape and a groove-like recess 15 is formed on its upper surface. The base portion 13 has a schematically cylindrical shape and the neck portion 12 has a schematically cylindrical shape thinner than the head portion 11 and the base portion 13. The lower surface of the head portion 11, the upper surface of the base portion 13 and the side peripheral surface of the neck portion 12 form an annular groove 16 on the side peripheral surface of the intermediate support body 10, and the inner peripheral surfaces of the head portion 11, the base portion 13 and the neck portion 12 are configured to form a through hole 14 axially passing through the insides of the head portion 11, the base portion 13 and the neck portion 12.

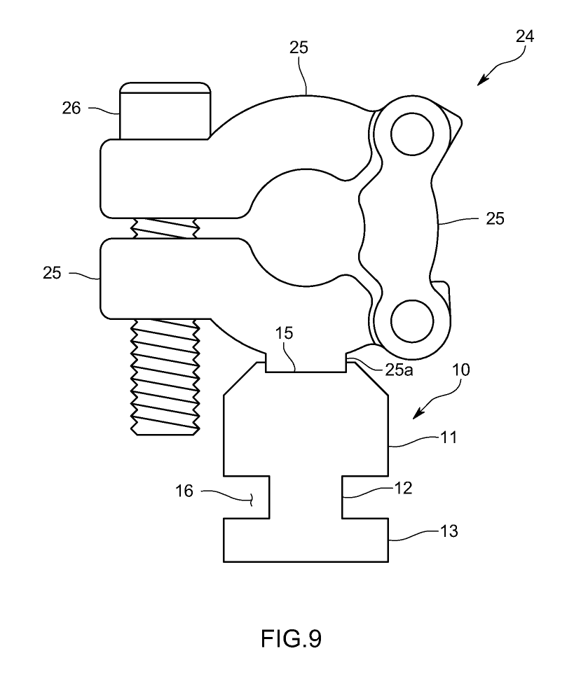

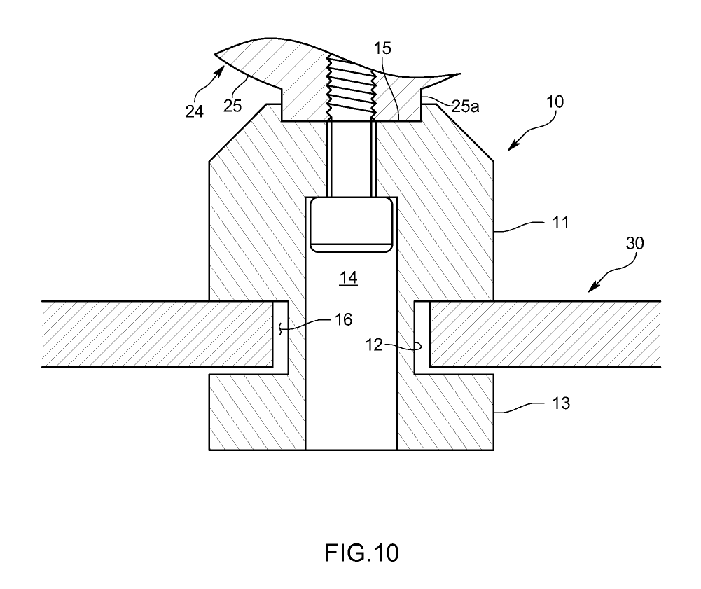

As shown in FIG. 9, the thick portion 25a provided at the bottom of the pipe joint 24 is fitted into the recess 15 of the intermediate support body 10. As shown in FIG. 10, a coupling member (i.e., bolt, in this example) penetrates the through hole 14 of the intermediate support body 10 and is screwed into a female threaded hole formed in the thick portion 25a of the pipe joint 24 so as to couple the pipe joint 24 and the intermediate support body 10.

As shown in FIG. 10, the width of the annular groove 16 of the intermediate support body 10 is set to be slightly larger than the thickness of the plate body 33. The outer diameter of the neck portion 12 of the intermediate support body 10 is set to be slightly smaller than the width of each of the first slide groove 31 and the second slide groove 32, and the outer diameters of the head portion 11 and base portion 13 of the intermediate support body 10 are set to be larger than the width of each of the first slide groove 31 and the second slide groove 32. The groove 16 is thus configured to be fitted to the plate body 33 forming the first and second grooves 31 and 32. As a result, the intermediate support body 10 is pivotably connected to the base member 30 and the intermediate support body 10 is attached to the base member 30 with a backlash so that the intermediate support body 10 can change its position or can be moved at least within a prescribed range. In this connection, the term “pivotably connected” means that the intermediate support body 10 can be rotated about an axis perpendicular to the attachment surface of the base member 30 as a center axis so that it is possible to keep the state of connecting the intermediate support body 10 to the base member 30 at any rotation angle.

As shown in FIG. 2, the intermediate support bodies 10 are arranged in each of the first slide grooves 31 and the second slide grooves 32, and each of the pipe joints 24 are attached to a respective intermediate support body 10. The fluid units 40 on the row fluid line are connected to each other by the pipe joints 24 located in the first slide grooves 31, and the fluid units 40 on the column fluid line are connected to each other by the pipe joints 24 located in the second slide grooves 32.

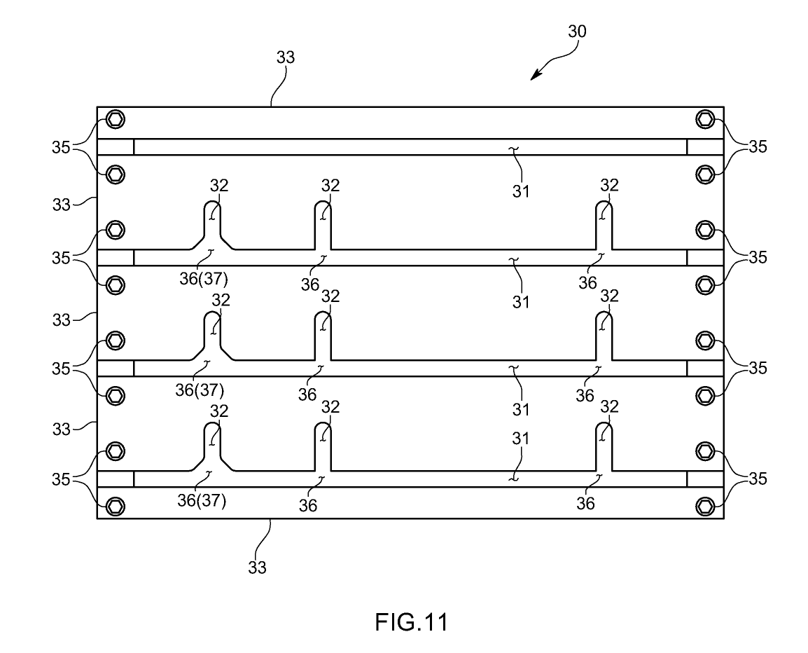

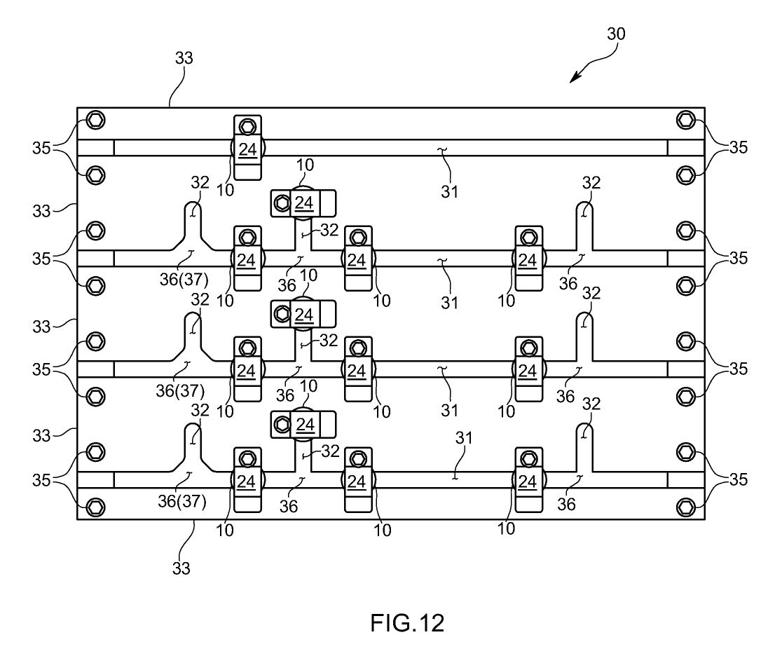

The following describes one example of a process of assembling the fluid system 100 pertaining to the present embodiment. As shown in FIG. 11, a notch is formed in a part of a proximal end of each of the second slide grooves 32 in the base member 30 so that a branched portion 36 between the first slide groove 31 and the second slide groove 32 has a size in diameter such that the bottom end of the intermediate support body 10 can be inserted therethrough. The branched portion 36 formed with the notch corresponds to a wide part 37 recited in claims. The intermediate support body 10 with the pipe joint 24 attached thereto is inserted through the wide part 37. In the state that the neck portion 12 of the intermediate support body 10 is inserted through the wide part 37, the intermediate support body 10 is moved along the first slide groove 31 and the second slide groove 32 so that the plate body 33 is fitted into the annular groove 16 of the intermediate support body 10. Similarly, the intermediate support bodies 10 are sequentially attached to the base member 30 so that the plurality of intermediate support bodies 10 are arranged in the first slide groove 31 and the second slide groove 32 as shown in FIG. 12. In order to attach the intermediate support body 10 to the first slide groove 31 without forming a wide part 37, the holding plate 34 is removed and the intermediate support body 10 is slid into the groove 31 from the side surface of the base member 30.

Further, the pipe joint 24 is situated in a released state that the unit members 25 at both ends are not coupled by the fastener 26. Then, the opposing pipes 50 are installed on the unit member 25 located at the bottom of the pipe joint 24, and thereafter the pipe joint 24 is set in a fastened state so that the paired fluid units 40 are connected to each other via the pipe joint 24. As another example of the assembling process, there may be exemplified that, after the fluid units 40 are connected by the pipe joint 24, the intermediate support body 10 is attached to the pipe joint 24 and the base member 30. In this case, however, when the fluid unit 40 is removed, the process is carried out in a reverse procedure.

According to the fluid system 100 pertaining to the present embodiment, since each of the intermediate support bodies 10 is attached to a pipe joint 24, there is no need to use the intermediate support bodies 10 of different heights and the common intermediate support bodies 10 can be used. Moreover, since the pipe joint 24 is relatively thick and it is not so difficult to provide a threaded hole there, the intermediate support body 10 can easily be attached directly to the pipe joint 24 by a screw even in a simple structure such as a column body of the intermediate support body 10. Further, regarding the attachment procedure, the paired fluid units 40 may be connected using the pipe joint 24 after the intermediate support body 10 is attached to the pipe joint 24 and the base member 30. Otherwise, the intermediate support body 10 may be attached to the pipe joint 24 and the base member 30 after the paired fluid units 40 are connected using the pipe joint 24. Thus, a preferable attachment procedure can be selected depending on an attachment situation and it is possible to improve workability.

Moreover, since the plate bodies 33 formed with the second slide grooves 32 in the same positions are used, the second slide grooves 32 can be aligned in one line so that the row fluid lines configured by connecting the plurality of fluid units 40 in series can be connected using the pipe joints 24 disposed in the second slide grooves 32. Further, since the second slide groove 32 extending in a direction different from that of the first slide groove 31, the pipe joints 24 can be attached to the base member 30 via the intermediate support bodies 10 located in the first slide groove 31 and the second slide groove 32 so that the fluid circuit device 101 can be fixed without providing an additional member for fixation. In addition, since the branched portion 36 between the first slide groove 31 and the second slide groove 32 is formed to be a wide space portion 37, the intermediate support body 10 can be detachably attached through a midway of each of the first slide grooves 31 and the second slide groove 32.

It is noted that the present invention is not limited to the present embodiment. For example, although the joining portions of the first slide groove and the second slide groove are partly formed to be wide space portions, all of the joining portions of the first slide groove and the second slide groove may be formed to be wide space portions, or the wide space portion may be provided in a portion other than the joining portion of the first slide groove and the second slide groove. Moreover, although the intermediate support body is inserted through the wide space portion, the intermediate support body may be inserted from the side surface of the base member after the holding plate of the base member is removed.

The intermediate support body may be coupled to the base member by screwing and the like. Although the second slide groove is branched from the first slide groove, it may be extended in a direction different from the extending direction of the first slide groove from the side in the widthwise direction of the plate body.

In addition, although the joint mechanism includes a positioning ring, the positioning ring may be omitted. With this configuration, the number of parts can be reduced, and when the fluid unit is attached and detached, it is merely necessary to axially move the pipe connected to the fluid unit only by a width of the positioning ring without necessity of attaching and detaching the positioning ring, and therefore the piping can be easily executed. In particular, in the case where the axial movement of the fluid unit is limited such as a case of attaching and detaching the fluid unit on the column fluid line for connecting the row fluid lines arranged in parallel to each other, this effect is still further remarkable.

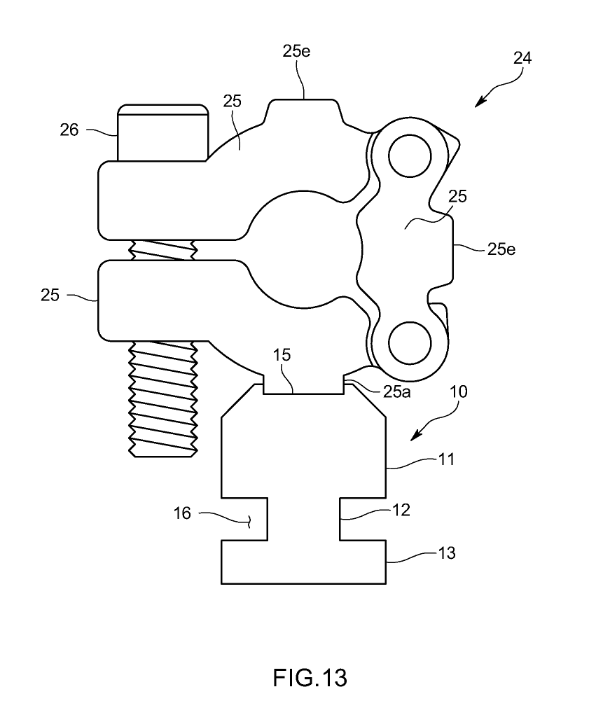

Moreover, as shown in FIG. 13, in order to ensure adequate strength for preventing cracks and the like, there may be provided a thick part 25e protruding outward at an intermediate portion of each of the unit members 25. This thick part 25e may have a width that is equal to or smaller than that of the unit member. It is only desirable that the width of the thick part 25e has the minimum size for ensuring the strength.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims. In addition, the components of the present invention may be combined and various changes and modifications can be made within the scope of the present invention unless departing from the spirit thereof.

### REFERENCE CHARACTER LIST

100 . . . Fluid system
101 . . . Fluid circuit device
102 . . . Holding mechanism
10 . . . Intermediate support body
24 . . . Pipe joint
30 . . . Base member
31 . . . First slide groove
32 . . . Second slide groove
33 . . . Plate body
40 . . . Fluid unit
50 . . . Pipe

1. A fluid system comprising:
a fluid circuit device configured by connecting a plurality of fluid units for controlling or measuring a state of fluid using pipes and pipe joints; and
a holding mechanism for holding the fluid circuit device, wherein
the holding mechanism includes a base member and intermediate support bodies each of which is interposed between the fluid circuit device and the base member so as to couple the fluid circuit device and the base member, and wherein
one end of each intermediate support body is attached to a respective pipe joint and the other end thereof is attached to the base member so that the intermediate support bodies connect each of the pipe joints to the base member.

2. The fluid system according to claim 1, wherein each intermediate support body pivotably connects the respective pipe joint to the base member.

3. The fluid system according to claim 1, wherein each intermediate support body is attached to the base member with a backlash so as to be able to change a position thereof or move at least within a prescribed range.

4. The fluid system according to claim 1, wherein the base member is formed with one or more first slide grooves and one or more second slide grooves, each of the other ends of the intermediate support bodies configured to slidably fit in a respective second slide groove, and wherein
each second slide groove is branched from a first slide groove in a direction different from an extending direction of the first slide groove.

5. The fluid system according to claim 4, wherein at least one of the first slide grooves or the second slide grooves are provided with a wide space portion through which the other end of the intermediate support body is inserted.

6. The fluid system according to claim 4, wherein the base member includes a plurality of lengthy rectangular plate bodies which are arranged to be spaced from each other with gaps, wherein each of the gaps forms each of the first slide grooves while at least one second slide groove is formed in each of the plate bodies.

7. The fluid system according to claim 6, wherein each intermediate support body is schematically column shaped and a side peripheral surface thereof is formed with a groove that is fitted to a plate body having the second slide groove formed therein whereby the intermediate support body is connected to the base member.

8. The fluid system according to claim 1, wherein the pipe joint includes a series of unit members wherein the unit members adjacent to each other are rotatably connected, and the pipe joint includes a fastener that connects the unit members located at both ends to form an annular series of the unit members so that the series of the unit members are externally fitted to opposing ends of each of a pair of the pipes so that the paired pipes are serially connected to each other by fastening the fastener, and wherein
the intermediate support body is attached to a unit member located at the bottom of the pipe joint.

9. A holding mechanism for use together with a fluid circuit device configured by connecting a plurality of fluid units for controlling or measuring a state of fluid using pipes and pipe joints, comprising:
a base member; and
an intermediate support body which is interposed between the fluid circuit device and the base member so as to couple the fluid circuit device and the base member, wherein
one end of the intermediate support body is attached to a respective pipe joint and the other end thereof is attached to the base member so that the intermediate support body connects the pipe joint to the base member so as to hold the fluid circuit device.

10. An intermediate support body for use together with a fluid circuit device configured by connecting a plurality of fluid units for controlling or measuring a state of fluid using pipes and pipe joints, and a base member for holding the fluid circuit device, wherein
the intermediate support body is interposed between the fluid circuit device and the base member so as to couple the fluid circuit device and the base member, and one end of the intermediate support body is attached to one of the pipe joints and another end thereof is attached to the base member so as to connect the pipe joint to the base member.
